(19) United States
(12) Patent Application Publication
(10) Pub. No.: US 2011/0229248 A1
(43) Pub. Date: Sep. 22, 2011

(54) Paint marker

(76) Inventor: Yaakov E. Oppen, Baltimore, MD (US)

(21) Appl. No.: 12/930,514

(22) Filed: Jan. 10, 2011

Related U.S. Application Data
(60) Provisional application No. 61/340,551, filed on Mar. 18, 2010.

(51) Int. Cl. B43K 8/02

(52) U.S. Cl. 401/261

(57) ABSTRACT

This drip less paint brush is the same thing as a large marker and just the cotton inside if there will be any depends on the thickness of paint made. This can also have plastic partitions in it that keep the paint in place. This could also have an opening in it on the top to put paint in [like in the handle]. It can be made in such a way as to do 2 colors or 3 at the same time exactly in line. Can also be used as waxier or with soap water. This is a paint marker.

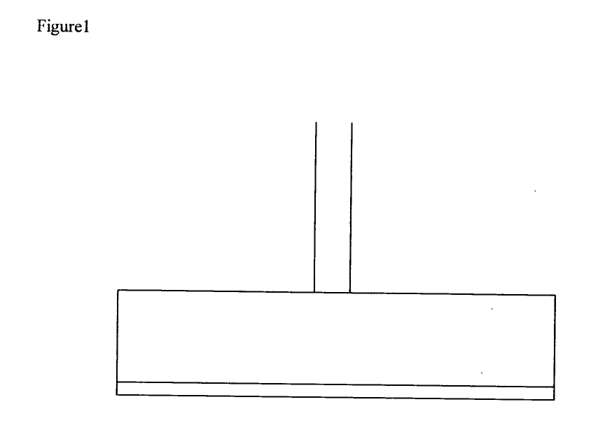

This drip less paint brush is the same thing as a large marker and just the cotton inside if there will be any depends on the thickness of paint made. This can also have plastic partitions in it that keep the paint in place. This could also have an opening in it on the top to put paint in [like in the handle].

It can be made in such a way as to do 2 colors or 3 at the same time exactly in line. Can also be used as waxier or with soap water. This is a paint marker. This specification is the same as the other with out the figure with no new matter.

1. My claim to this is it being my idea of a way that will help people in painting and waxing and cleaning.
